(19) United States
(12) Patent Application Publication
(10) Pub. No.: US 2018/0365508 A1
(43) Pub. Date: Dec. 20, 2018

(54) CODE PROVIDING DEVICE AND CODE IDENTIFICATION SYSTEM USING LIGHT EMITTING MEANS OR COLOR INFORMATION

(71) Applicant: Dong Geon KIM, Seoul (KR)

(72) Inventors: Keun Jei KIM, Seoul (KR); Young Kyu KIM, Seoul (KR); Dong Keon KIM, Seoul (KR)

(21) Appl. No.: 15/562,993

(22) PCT Filed: Mar. 14, 2016
(86) PCT No.: PCT/KR2016/002512

§ 371 Date: Sep. 29, 2017

(30) Foreign Application Priority Data
Apr. 8, 2015 (KR) 10-2015-0049886

(51) Int. Cl. G06K 9/32; G06K 9/20; G06K 9/46

(52) U.S. Cl. CPC G06K 9/325; G06K 9/2027; G06K 2209/15; G06K 9/4652; G06K 9/4661

(57) ABSTRACT

Disclosed are a code providing device and a code identification system using a light emitting means or color information. A characteristic code providing device according to an embodiment includes an identification plate, multiple light emitting means disposed at predetermined positions on the identification plate, and a light emission control unit for generating a light-emission control signal for each of the multiple light emitting means, and controlling the light emission of each of the multiple light emitting means using the generated light emission control signal, so as to provide the characteristic code through the light emission of the multiple light emitting means.

### TECHNICAL FIELD

Example embodiments of the inventive concept relate to a technology providing a characteristic code and identifying the characteristic code using an image, and in particular, to an apparatus and a system for providing a characteristic code using light emitted from a plurality of light-emitting devices and identifying the characteristic code using an image.

### BACKGROUND ART

A variety of security systems are being used. For example, a security system is used to sense the presence of cars in a specific region of a road and take an image of a license plate of the car based on the result of the sensing process, extract numerical and/or letter characters from the taken image to identify or recognize the license plate of the car.

For an example, a vehicle license plate recognition system can extract information on license plates of cars using a high-performance license plate recognition (LPR) system. The use of the LPR system can make it possible to output recognition data in the form of text, which is obtained from a license plate region of a taken image using the optical character recognition (OCR) function thereof.

For another example, when there occurs a missing alert (e.g., a lost child, a mentally handicapped person, an aged person with dementia, or the like), the missing person can be found using a security system. This is configured to automatically analyze CCTV images from a nearby camera, determine a position of the missing person, propagate the situation, and control the detected object intensively and continuously in conjunction with the nearby CCTV.

However, a security or recognition system that uses the conventional technology requires a high-resolution CCTV camera for obtaining high-resolution images and a high-performance system for recognizing and identifying the high-resolution image.

Furthermore, the security or recognition system that uses the conventional technology can increase in error rate of recognition and identification processes, which can be caused by a change in weather, a difference between daytime and nighttime recognition, a change in moving speed of a target object. In addition, it can be challenging to perform the recognition process normally when there is a difference in viewing angle of a license plate or if a car is moving on overlapped lanes.

### DISCLOSURE

### Technical Problem

Embodiments of the inventive concept provide a characteristic code-providing device capable of providing characteristic code information through a light-emission control of multiple light emitting means.

Embodiments also provide a characteristic code identification system using a light emitting means, which is capable of identifying a characteristic code corresponding to light-emission information using an image obtained by taking the light-emission information of multiple light emitting means.

### Technical Solution

A characteristic code-providing device according to an embodiment includes an identification plate; multiple light emitting means disposed on a predetermined position of the identification plate; a light-emission control unit generating a light-emission control signal of each of the multiple light emitting means corresponding to the characteristic code and controlling light-emission of each of the multiple light emitting means by using the generated light-emission control signal, thereby providing the predetermined characteristic code of the object through the light-emission of the multiple light emitting means.

The light-emission control unit can control a light-emission color of each of the light emitting means to provide the characteristic code through a combination of the light-emission color of each of the multiple light emitting means.

The light-emission control unit can control on/off of the light-emission of each of the multiple light emitting means to provide the characteristic code through an arrangement of on-state light emitting means in a light-emission on-state and an arrangement of off-state light emitting means in a light-emission off-state of the multiple light emitting means

The light-emission control unit can control a change in the light-emission color of each of the multiple light emitting means to provide the characteristic code through the change in the light-emission color of each of the multiple light emitting means.

The light-emission control unit can control a change in the light-emission on/off of each of the multiple light emitting means to provide the characteristic code through the change in the light-emission on/off of each of the multiple light emitting means.

The multiple light emitting means can include at least one parity light emitting means disposed at a predetermined position for determining whether there is an error in the multiple light emitting means, and the light-emission control unit can control the light-emission of the parity light emitting means depending on whether there is an error in the multiple light emitting means.

The object can include motorcycles, cars, electric wheelchairs, personal transportation vehicles, vessels, motor boats, mid-air objects, animals and human-beings.

The characteristic code identification device according to an embodiment includes: a receiving unit receiving image information including the light-emission information of the multiple light emitting means taked by the image taking means; an extracting unit extracting the light-emission information from the image information; and an identifying unit identifying the characteristic code corresponding to the light-emission information based on the light-emission information of the multiple light emitting means.

The identifying unit can acquire the parity light-emission information representing whether there is an error in the multiple light emitting means from the extracted light-emission information, and identify the characteristic code based on the light-emission information of each of the multiple light emitting means when it is determined as the multiple light emitting means are normal by the acquired parity light-emission information.

The extracting unit can extract text information for a predetermined area from the image information, and the identifying unit can acquire the parity light-emission information representing whether there is an error in the multiple light emitting means from the extracted light-emission information, and identify the characteristic code based on the light-emission information of each of multiple light emitting means and the extracted text information when it is determined that at least one of the multiple light emitting means is abnormal by the acquired parity light-emission information.

The indentifying unit can correct the light-emission information for at least one light emitting means determined to be abnormal using the extracted text information, and identify the characteristic code based on the light-emission information of each of the multiple light emitting means including the corrected light-emission information.

The identifying unit can acquire a combination of the light-emission color of each of the multiple light emitting means from the extracted light-emission information and identify the characteristic code through the acquired combination of the light-emission color.

The identifying unit can acquire an arrangement of on-state light emitting means in a light-emission on-state and an arrangement of off-state light emitting means in a light-emission off-state of the multiple light emitting means from the extracted light-emission information, and identify the characteristic code through the acquired arrangement of on-light emitting means and the acquired arrangement of off-light emitting means.

The identifying unit can acquire a change in the light-emission color of each of the multiple light emitting means from the extracted light-emission information and identify the characteristic code through the change in the acquired light-emission color.

The identifying unit can acquire a change in on/off state of each of the multiple light emitting means from the extracted light-emission information and identify the characteristic code through the acquired change in on/off.

Further, the characteristic code identification system according to an embodiment can include a chasing unit chasing a movement path of the object to which the multiple light emitting means is attached using the identified characteristic code.

Further, the characteristic code identification system according to an embodiment can further include an acquiring unit acquiring an object to which the multiple light emitting means having the identified characteristic code is attached.

The characteristic code identification system according to an embodiment includes multiple light emitting means, a characteristic code providing means providing a characteristic code of an object through light-emission of the multiple light emitting means; an image taking means taking an image including the light-emission information of the multiple light-emission means provided through the characteristic code providing means; and an characteristic code identification means identifying the characteristic code of the object based the light-emission information included in the taken image.

The characteristic code identification means can acquire a parity light-emission information representing whether there is an error in the multiple light emitting means from the light-emission information and identify the characteristic code based on the light-emission information of each of the multiple light emitting means when it is determined that the multiple light emitting means is normal by the acquired parity light-emission information.

The characteristic code identification means can acquire parity light-emission information representing whether there is an error in the multiple light emitting means from the extracted light-emission information, and extract text information for a predetermined area from the image information when it is determined that at least one of the multiple light emitting means is abnormal by the acquired parity light-emission information, correct the light-emission information for at least one light emitting means determined to be abnormal by using the extracted text information, and indentify the characteristic code based on the light-emission information of each of the multiple light emitting means including the corrected light-emission information.

### Advantageous Effects

Embodiments can provide characteristic code information through a light-emission control of multiple light emitting means, and identify a characteristic code corresponding to light-emission information by using an image that takes the light-emission information of multiple light emitting means, thereby recognizing an object with the characteristic code.

Embodiments can only require minimally specified video equipment and system to allow for taking and identifying the light-emission information because the characteristic code is identified that uses the light-emission information. Therefore, it is possible to reduce a system installation cost because there is no need to provide high-performance video equipment and a high-performance system to allow for taking, reading, or identifying a text.

Embodiments can reduce an influence caused by weather and a surrounding environment because the characteristic code is identified that uses the light-emission information, and reduce an influence due to factors such as a speed of the object, a recognition angle, and a distance even when the object moves.

Embodiments can identify the characteristic code of the object and chase a position and a moving path of the object by attaching the characteristic code providing device to the object, for example, not only moving vehicles including cars and motorcycles, but also human-beings including missing children, mentally handicapped peoples, and aged peoples with dementia.

Embodiments can be applied to various applications that can identify the characteristic code of the object, for example, a parking lot settlement system, a highway settlement system, an illegal parking regulation system, an speeding/signal violation control system, and an object position chasing system.

### DESCRIPTION OF DRAWINGS

FIG. 1 shows a conceptual structure for a characteristic code identification system according to an embodiment.

FIG. 2 shows a configuration of an embodiment for a characteristic code providing device shown in FIG. 1.

FIG. 3 shows a configuration of an embodiment of the characteristic code identification system shown in FIG. 1.

FIG. 4 shows embodiments for arrangements of multiple light emitting means in an identification plate.

FIGS. 5 to 7 show embodiments for illustrating a method of providing a characteristic code using a light emitting means.

FIG. 8 shows embodiments for illustrating a method of identifying a characteristic code according to light-emission information of a parity light emitting means.

FIG. 9 shows a flowchart illustrating operations of an embodiment for process of providing a characteristic code.

FIG. 10 shows a flowchart illustrating an operation of an embodiment of a process of identifying a characteristic code.

### BEST MODE

Hereinafter, embodiments will be described in detail with reference to accompanying drawings. However, the present invention is not limited to or limited by the embodiments. In addition, the same reference numerals shown in the drawings denote the same members.

Example embodiments of the inventive concepts are based on providing and identifying a characteristic code using multiple light emitting means by controlling light-emission of the multiple light emitting means, analyzing an image obtained by taking light-emission information, and identifying the characteristic code corresponding to the light-emission information, thereby providing the light-emission information corresponding to the characteristic code.

The characteristic code provided in the embodiments can include one or more of a vehicle number, a model, a vehicle model year, a vehicle color, and the like, in a case of a car; or a resident number(,) the status of a person (for example, dementia, a person with a disability, an infant, etc.), physical information, a disability grade, and the like, in a case of person.

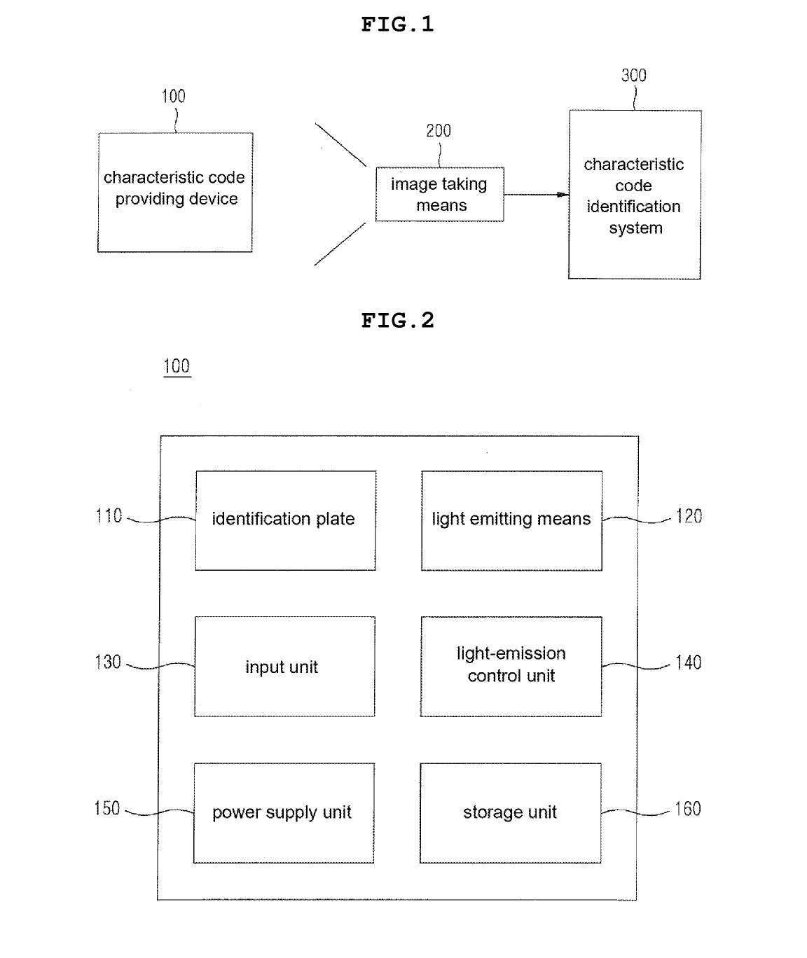

FIG. 1 shows a conceptual structure of an characteristic code identification system according to an embodiment.

Referring to FIG. 1, the characteristic code identification system according to an embodiment includes a characteristic code providing device 100, an image taking means 200, and a characteristic code identification system 300.

The characteristic code providing device 100 is a device that is attached to an object, such as a land moving means such as a motorcycle, an automobile, and a personal moving means (for example, an electric scooter, an electric wheelchair, a Ninebot, etc.), a marine moving means such as a ship, a motor boat, mid-air vehicles including a future personal vehicle and the like, mid-air vehicles including future personal vehicle, mid-air objects, animals, or human beings, and can include multiple light-emitting means for providing light-emission information corresponding to a characteristic code of the object.

Herein, the light emitting means can include all kinds of means for generating light, such as an light emitting diode (LED), optical fiber, and so on, and the LED can include all kinds of LEDs, such as a visible light LED, an ultraviolet LED, infrared LED, a monochromatic LED, 3 color (red, blue, and yellow) LEDs, 7 color LEDs, OLEDs, and so on. Depending on situations, the characteristic code providing device 100 does not have to use only light emitting means in a manner of providing the characteristic code of the object, but can use various methods capable of providing the characteristic code of the object in colors. For example, the characteristic code providing device 100 can provide the characteristic code using colored stickers, paper, plastic, reflectors, etc., and can also provide the characteristic code of the object using various methods of distinguishing colors.

In the embodiment, it is explained that the characteristic code of the object is provided by using the light emitting means.

The characteristic code providing device 100 can be attached to a moving means such as a motorcycle, a car, and the like to provide light-emission information corresponding to the characteristic code, and can be attached to a person such as a missing child, a mentally handicapped person, and an aged person with dementia to provide the light-emission information corresponding to the characteristic code of the corresponding person.

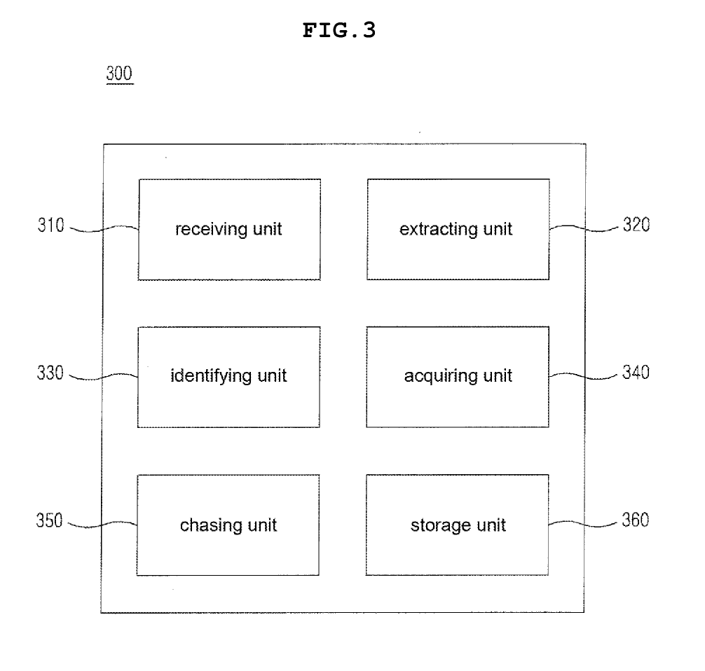

The characteristic code providing device 100 can provide the characteristic code through various control methods of the multiple light emitting means, which will be described referring to FIG. 2.

The characteristic code provided by the characteristic code providing device 100 can be text information composed of numbers and letters written on a license plate of a moving means, and can be information corresponding to a characteristic of a person, for example, information such as a resident number and a name.

The image taking means 200 takes the light-emission information of the characteristic code providing device 100 that is attached to the object, and provides the characteristic code identification system 300 with the image information including the taked light-emission information.

Herein, the image taking means 200 can include all image taking means such as a CCTV and a camera, and can have a specification to allow for taking the light-emission information.

The image taking means 200 can take a surrounding image at a predetermined place and position. For example, the image taking means 200 can be a camera for detecting a signal and speeding at a specific position on the road, or can a surveillance camera for preventing crimes in a residential area.

The characteristic code identification system 300 receives the image information obtained by taking the image taking means 200, and identifies the characteristic code corresponding to light-emission information included in the image information by analyzing the received image information.

At this time, the characteristic code identification system 300 acquires an object corresponding to the identified characteristic code and thus acquires the information on the object.

At this time, the characteristic code identification system 300 confirms a position of the object having the characteristic code or chases a moving path thereof, using the identified characteristic code.

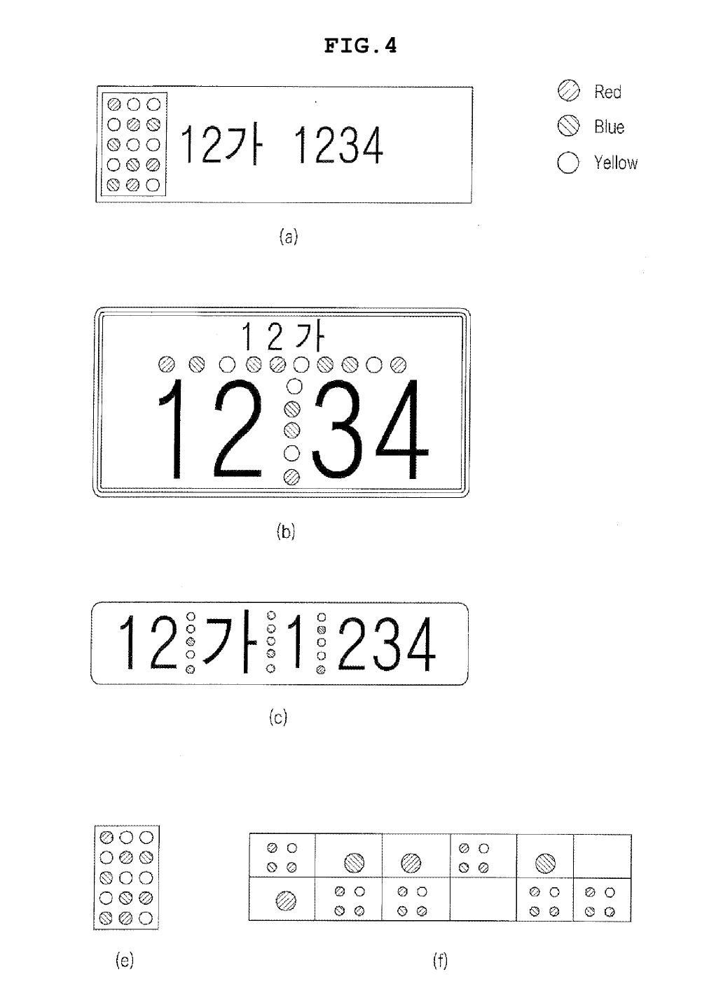

The characteristic code identification system 300 can identify the characteristic code through identification methods corresponding to various method of providing the light-emission information in the characteristic code providing device 100, which will be described in FIG. 3.

Depending on situations, the characteristic code identification system 300 can identify the characteristic code corresponding to the light-emission information using the text information as well as the light-emission information, when the image information received from the image taking means 200 includes the light-emission information and the text information.

The characteristic code providing device 100 and the characteristic code identification system 300 will be described below referring to FIG. 2 and FIG. 3.

FIG. 2 shows a configuration of an embodiment for the characteristic code providing device shown in FIG. 1.

Referring to FIG. 2, the characteristic code providing device 100 includes an identification plate 110, a light emitting means 120, an input unit 130, a light-emission control unit 140, a power supply unit 150, and a storage unit 160.

The identification plate 110 is a means for disposing each of multiple light emitting means 120 at a predetermined position. The identification plate 110 includes a text for a vehicle characteristic code (a vehicle number) or a motorcycle characteristic code (a motorcycle number), or can not include it depending on situations, when the identification plate is a vehicle license plate, a motorcycle license plate, or the like.

The identification plate 110 can have a predetermined form and size.

The light emitting means 120 is a means for providing the light-emission information corresponding to the characteristic code of the object, and the multiple light emitting means 120 are disposed in a predetermined form at a predetermined position of the identification plate.

Each of multiple light emitting means 120 can include a LED, an optical fiber, and so on, which can be all colors of optical fiber and all kinds of LEDs such as a visible light LED, an ultraviolet LED, an infrared LED, a monochromatic LED, a 3 color (Red, Blue, Yellow) LED, a 7 colors LED, an OLED, and so on.

At this time, the light emitting means 120 can disposed at a predetermined area capable of providing information for the characteristic code, for example each of numbers and characters composing a text of “12 [symbol] |-1234”, or can be disposed at an area corresponding to total text.

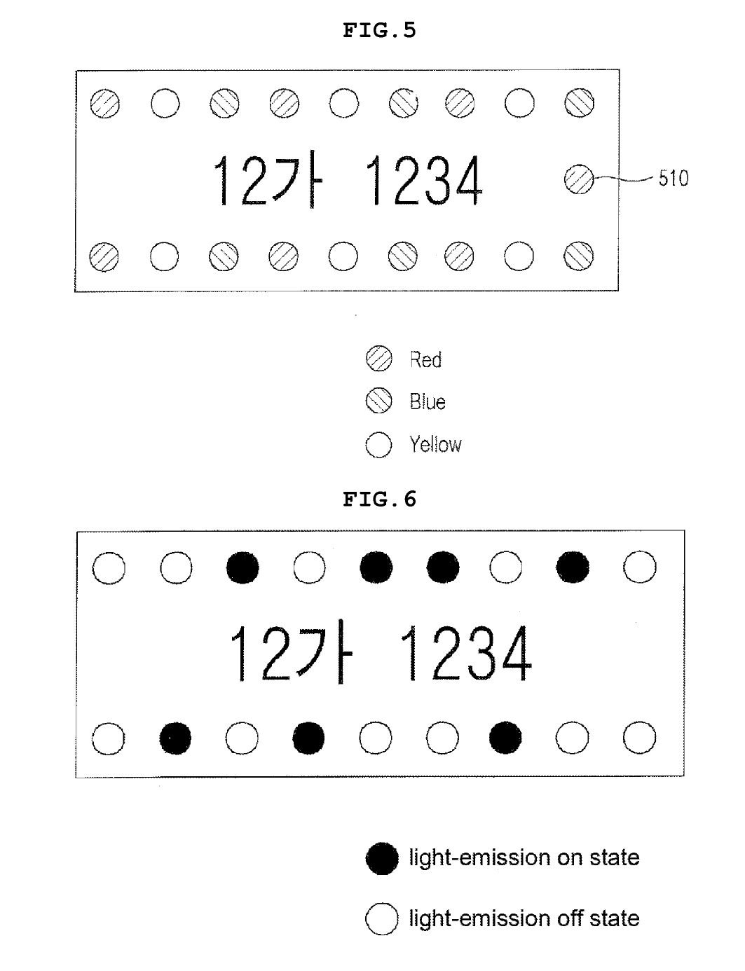

As an example, as shown in FIG. 4a, a LED panel having multiple light emitting means arranged in 3×5 array is disposed in a left area of the license plate, so that the LED panel disposed on the left side of the license plate can be used to provide the light-emission information corresponding to the characteristic code.

As another example, as shown in FIG. 4b, by arranging the multiple light emitting means in a letter “T” shape on another type of license plate, it is possible to provide the light emitting information corresponding to the characteristic code by using the multiple light emitting means arranged in a letter “T” shape.

As another example, as shown in FIG. 4C, by arranging the multiple light emitting means in a linear shape at an area between the numbers of the license plate, the light-emission information corresponding to the characteristic code can be acquired by using multiple light emitting means arranged in the linear shape.

Further, the light emitting means 120 can be disposed on the identification plate without any text containing numbers and letters. For example, as shown in FIG. 4D and FIG. 4E, it can be constituted of combination of only light emitting means.

Of course, an arrangement type of the multiple light emitting means is not limited to only example shown in FIG. 4, but have various arrangement types capable of providing the characteristic code. An arrangement of the text and an arrangement of the light emitting means shown in FIG. 4, and a size of the identification plate are arbitrarily adjusted for the purpose of convenience of explanation. Further, such light emitting means can be attached to various objects such as human-beings, animals and the like, as well as the license plate.

Further, although the multiple light emitting means 120 is shown to be disposed in the vehicle license plate in FIG. 4, a position where the multiple light emitting means is disposed is not limited to the vehicle license plate, but can be disposed at a specific position in the car, for example, a front windshield, an internal position of the vehicle capable of outputting light-emission information to the outside, and the like.

At least one of the multiple light emitting means 120 can be a parity light emitting means to determine whether the multiple light emitting means are operating normally or erroneously, and the parity light emitting means can be disposed in a predetermined position of the identification plate.

The input unit 130 is a means for inputting the characteristic code of the object, which can not be provided with the characteristic code providing device 100 depending on situations.

For example, when the characteristic code of the object is input by an external input means, the characteristic code providing device 100 does not need to be provided with the input unit 120. That is, the characteristic code set in the characteristic providing device 100 can be input or set only by a predetermined agency or manager to prevent the characteristic code from being changed by an ordinary user.

The power supply unit 150 supplies power to each of blocks constituting the characteristic code providing device, such as the multiple light emitting means 120 and the light-emission control unit 140.

The light-emission control unit 140 generates light-emission control signals of each of the multiple light emitting means corresponding to the characteristic code and control the light-emission of each of the multiple light emitting means using the generated light-emission control signal, so as to provide the characteristic code of the object through the light-emission of the multiple light emitting means.

The light-emission control unit 140 can provide the light-emission information corresponding to characteristic code using the multiple light emitting means, and the light-emission information corresponding to the characteristic code can be provided by various methods.

In this case, the light-emission control unit 140 can vary the method of generating the light-emission control signals of each of the multiple light emitting means corresponding to the characteristic code according to the method of providing the light-emission information. By analyzing numbers or letters constituting the characteristic code according to the manner of providing, it is possible to generate light-emission control signals for each of the multiple light emitting means.

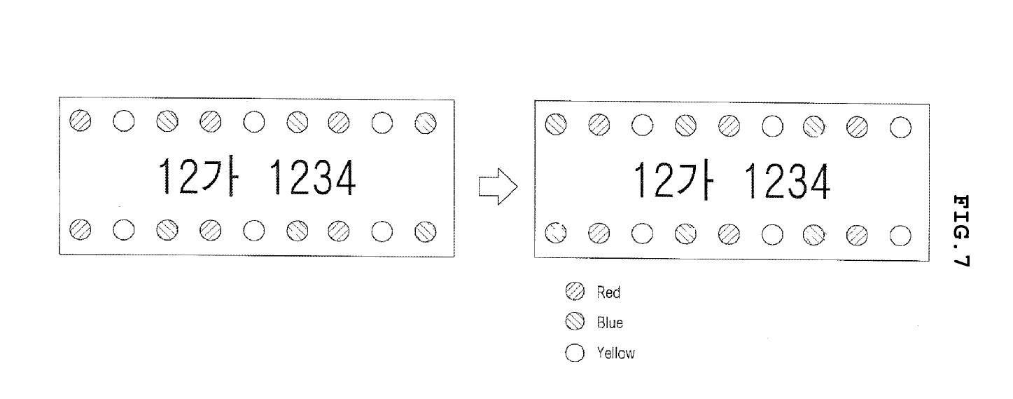

As one example, the light-emission control unit 140 can provide the characteristic code through a combination of light-emission color of each of the multiple light emitting means by controlling a light-emission color (red, blue, yellow, and the like) of each of the multiple light emitting means, as shown in FIG. 5. In this case, each of the light emitting means can be a three-color LED capable of emitting colors of red, blue, and yellow, or a seven-color LED capable of emitting seven colors.

Any one light emitting means 510 of the light emitting means shown in FIG. 5 is a parity light emitting means for providing information on whether the multiple light emitting means providing the characteristic code is erroneously or normally operated, and the light-emission control unit 140 can control the light-emission color of the parity light emitting means 510 according to whether or not the multiple light emitting means providing the characteristic code are normally operated. For example, the light-emission control unit 140 can control such that the parity light emitting means 510 can emit the light in red when all of the multiple light emitting means providing the light-emission information for the characteristic code are normal, the parity light emitting means 510 can emit light in blue when one of the multiple light emitting means is abnormal, and the parity light emitting means 510 can emit the light in yellow when several of the multiple light emitting means are abnormal. The light-emission information of the parity light emitting means 510 can be used as information for identifying the characteristic code using the light-emission information in the characteristic code providing device.

Further, as shown in FIG. 5, when each of the multiple light emitting means is a tri-color LED and has 18 units, the light emitting means can represent 3¹⁸ characteristic codes.

As another example, the light-emission control unit 140 controls light-emission on or off of each of the multiple light emitting means, as shown in FIG. 6, to provide the characteristic code through a combination of on/off of each light emitting means. In this case, when each light emitting means can be a single-color LED, and has 18 units, the light emitting means can represent 2¹⁸ characteristic codes.

As another example, when each of the multiple light emitting means is a single-color light emitting means, for example, single-color LED, as shown in FIG. 6, the light-emission control unit 140 can control the light-emission on or off of each of the multiple light emitting means, to provide the characteristic code through an arrangement of on-state light emitting means in light-emission on-state and an arrangement of off-state light emitting means in light-emission off-state of the multiple light emitting means. In other words, the light-emission control unit can control on/off the multiple light emitting means so as to provide the characteristic code using the arrangement of the light emitting means in light-emission on-state and the arrangement of the light emitting means in light-emission off-state.

As another example, the light-emission control unit 140 controls a change in the light-emission of each of the multiple light emitting means, as shown in FIG. 7, thereby providing the characteristic code through the change in the light-emission of each of the multiple light emitting means. For example, as shown in FIG. 7, the light-emission control unit 140 can change the color from red to blue or yellow for any light emitting means, change the color from blue to yellow or red for any light emitting means, change the color from yellow to red or blue for any light emitting means, so as to provide a color change corresponding to the characteristic code at a predetermined time period. Of course, the light emitting means can not change color for any light emitting means.

As another example, the light-emission control unit 140 can provide the characteristic code through a change in on/off state of each of the multiple light emitting means by controlling the change in the light-emission on/off of each of the multiple light emitting means. That is, the light-emission control unit 140 can provide the light-emission information for the characteristic code through the change in on/off state of each light emitting means at a predetermined time period.

The storage unit 160 stores an algorithm for generating a light-emission control signal corresponding to the characteristic code in the characteristic code providing device, the characteristic code of the object, and data required for the characteristic code providing device.

In addition, the characteristic code providing device according to the embodiment of the present invention is not limited to the use of the light emitting means described above, but can be configured using a color information providing means capable of providing the color information, in which the color information of the color information providing means is controlled to provide the color information corresponding to the characteristic code or a code.

FIG. 3 shows a configuration of an embodiment for the characteristic code identification system shown in FIG. 1.

Referring to FIG.3, the characteristic code identification system 300 includes a receiving unit 310, an extracting unit 320, an identification unit 330, an acquiring unit 340, a chasing unit 350, and a storage unit 360.

The receiving unit 310 receives images or image information including the light-emission information of the multiple light emitting means taked by the image taking means from the image taking means.

Of course, the receiving unit 310 is not limited to receiving the image information directly from the image taking means, but can receive them through an external storage means or the like.

The extracting unit 320 extracts the light-emission information from the received image information.

At this time, the extracting unit 320 can extract the light-emission information and the text information together when the text information is included in a predetermined area of the image information.

At this time, when the multiple light emitting means are disposed on the identification plate, the extracting unit 320 can extract the light-emission information and the text information from the image information for the region of the identification plate.

The extraction unit 320 can extract the light-emission information using various methods for the region in which the multiple light emitting means are disposed in the image information.

For example, the extraction unit 320 can extract the light-emission information for a light emitting region by using methods such as RGB (red, green, blue), HSV (hue, saturation, value), YCbCr (Y: luminance, CbCr: color difference signal (blue, red series)), and the like, in order to reduce an error rate for light or color acquisition with factors considered in the surrounding environment upon extracting the light-emission information.

The identification unit 330 identifies the characteristic code corresponding to the light-emission information based on the extracted light-emission information of the multiple light emitting means.

At this time, the identification unit 330 can identify the characteristic code corresponding to the light-emission information by using an identification scheme for providing the light-emission information corresponding to the characteristic code in the characteristic code providing device.

For example, as shown in FIG. 5, when the characteristic code providing device provides the characteristic code through a combination of light-emission color of each of the multiple light emitting means by controlling the light-emission color of each of the multiple light emitting means, the identification unit 330 can acquire a combination of the light-emission color of each of the multiple light emitting means from the extracted light-emission information and identify the characteristic code through the acquired combination of the light-emission color.

In another example, when the characteristic code providing device controls the on/off of the light-emission each of the multiple light emitting means to provide the characteristic code through a combination of on/off of each light emitting means, the identification unit 330 can acquire the combination of the on/off of the light-emission of each of the multiple light emitting means from the extracted light-emission information, and identify the characteristic code through the acquired combination of the on/off of the light-emission.

In another example, when the characteristic code providing device controls the light-emission on or off of each of the multiple light emitting means, as shown in FIG. 6, to provide the characteristic code through an arrangement of an on-state light emitting means in light-emission on-state and an arrangement of an off-state light emitting means in light-emission off-state of the multiple light emitting means, the identification unit 330 can acquire the arrangement of the on-state light emitting means and the arrangement of the off-state light emitting means of the multiple light emitting means from the extracted light-emission information, and identify the characteristic code through the arrangement of the on-light emitting means and the arrangement of the off-light emitting means which are acquired.

As another example, when the characteristic code providing device controls a change in the light-emission color of each of the multiple light emitting means to provide the characteristic code through the change in the light-emission color of each of plurality of light emitting means, as shown in FIG. 7, the identification unit 330 can acquire the change in the light-emission color of each of the multiple light emitting means from the extracted light-emission information and identify the characteristic code through the acquired change in the light-emission color.

As another example, when the characteristic code providing device controls the on/off of the light-emission of each of the multiple light emitting means to provide the characteristic code through a change in the light-emission on/off of each of the multiple light emitting means, the identification unit 330 can acquire the change in light-emission on/off of each of the multiple light emitting means from the extracted light-emission information and identify the characteristic code through the acquired change in the light-emission on/off.

As such, the identification unit 330 uses a method corresponding to method of providing the light-emission information in the characteristic code providing device, thereby identifying the characteristic code of the object from the extracted light-emission information. The method of providing the light-emission information in the characteristic code providing device and the method of identifying the characteristic code in the characteristic code identification system can be determined by a provider providing the corresponding technology.

Further, the identification unit 330 can acquire a parity light-emission information representing whether there is an error in the multiple light emitting means from the extracted light-emission information, and identify the characteristic code based on the light-emission information of each of the multiple light emitting means and text information extracted by the extracting unit 320 when it is determined that at least one of the multiple light emitting means is abnormal through the acquired parity light-emission information.

At this time, the identification unit 330 corrects the light-emission information for at least one light emitting means that is determined to be abnormal using the extracted text information, and identifies the characteristic code of the object based on light-emission information of each of the multiple light emitting means including the corrected light-emission information.

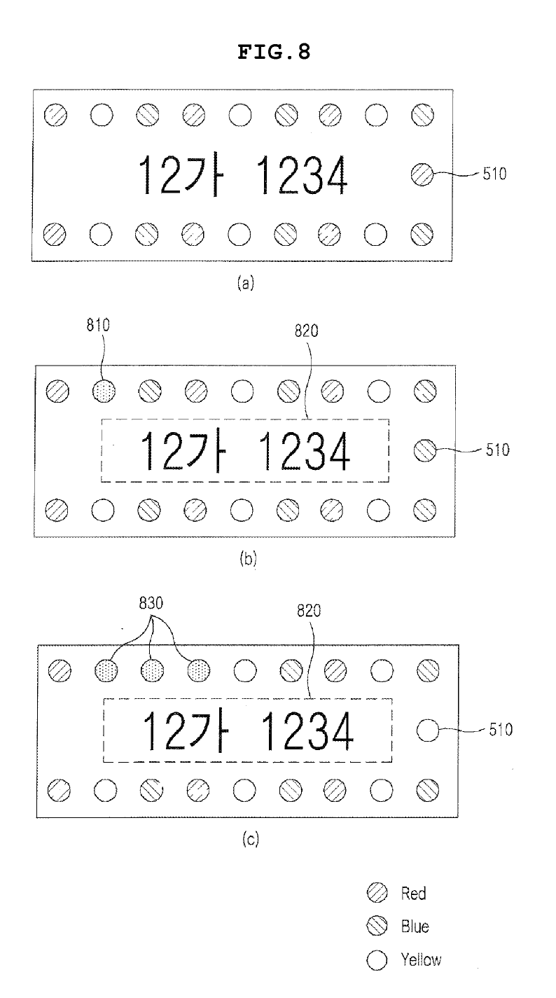

Specifically, when the extracted parity light-emission information of the parity light emitting means 510 is red as shown in FIG. 8a, the identification unit 330 determines that the multiple light emitting means are normal and identifies the characteristic code of the object using the extracted light-emission information of the multiple light emitting means.

Further, when the extracted parity light-emission information of the parity light emitting means 510 is blue, as shown in FIG. 8b, the identification unit 330 determines that one 810 of the multiple light emitting means is abnormal and corrects the light-emission information of the abnormal light emitting means using the extracted text information 820, thereby identifying the characteristic code of the object using the light-emission information of each of the multiple light emitting means including the corrected light-emission information.

On the other hand, when the extracted parity light-emission information of the parity light emitting means 510 is yellow as shown in FIG. 8C, the identification unit 330 determines that several 830 of the multiple light emitting means are abnormal, whereby the light-emission information is unreliable and the characteristic code is extracted using only the extracted text information 820. Of course, in this case, because it can be likely difficult to extract the characteristic code using only the text information 820 when the identification unit 330 takes an image using a low-performance image taking means, the characteristic code identification system can transfer the corresponding image information to a predetermined server or device that extracts the license plate of the vehicle using a high-performance license plate recognition (LPR) engine and the like which has already been built, to identify the characteristic code.

Also, the identification unit 330 can perform a function of comparing the characteristic code corresponding to the extracted light-emission information with information stored in an external database equipped in the outside, to acquire the information stored in the external database.

The acquiring unit 340 acquires the object or object information to which the multiple light emitting means having the identified characteristic code is attached.

Herein, the object information can include information on a vehicle type, a model year, a vehicle color, a vehicle owner, and the like, when the characteristic code is a vehicle number, and can include information on a person's status (for example, dementia, disabled, infant, etc.), body information, a disability grade, age, a place of residence, and the like, when the characteristic code is a person's number.

At this time, the acquiring unit 340 can search the identified characteristic code in a database or a storing unit that stores the object information for the characteristic code, to acquire the object information having the identified characteristic code.

The chasing unit 350 chases a movement path of the object to which the multiple light emitting means are attached using the identified characteristic code.

At this time, the chasing unit 350 detects the characteristic code from a storage means or a storage that stores the extracted characteristic code using the image information received through the image taking means, to chase the movement path of the object having the characteristic code to be chaseed. Of course, the image information can include all information for chasing the movement path of the object, such as information (e.g., an installation position, an ID, etc.) for the image taking means that takes the corresponding image, a taking time, and the like.

The storage unit 360 stores an algorithm capable of identifying the characteristic code using the light-emission information or the text information in the characteristic code identification system, for example, an algorithm for identifying the characteristic code according to the light-emission information, and an algorithm for image processing, and various information and data required for the corresponding device as well as the received image information.

As described above, since the characteristic code providing device and the characteristic code identification system according to the embodiment provide and identify the characteristic code using the light-emission information of the light emitting means, it is only necessary to have minimally specified video equipment and system to allow for taking and identifying the light-emission information. Therefore, there is no need to provide high-performance video equipment and a high-performance system to allow for taking, reading, or identifying text, thereby reducing the installation cost of the system.

In addition, since embodiments identify the characteristic code using the light-emission information, it is possible to reduce influences caused by the weather and the surrounding environment. Even when the object moves, it is possible to reduce influences due to factors such as speed, a recognition angle, and a distance of the object.

In addition, the embodiments can identify the characteristic code of the object and chase a position and a movement path of the object, by attaching the characteristic code providing device to the object, such as a missing child, a mentally handicapped person, and an aged person with dementia, as well as a mobile device including a motor vehicle or a motorcycle.

These embodiments can be utilized for various applications.

For example, a CCTV can be utilized for a parking lot settlement system. A camera, a computer system, and a network device are required as components of the parking lot settlement system, whereas it is possible to configure an automation system with a single network camera.

As another example, it is possible to cope with a toll road settlement system and a highway high pass settlement system. A high pass card and a RF transmitter are required as items equipped in a car and a RF receiver and a computer system are required as the highway settlement system. It is also possible to configure an automation system with a single network camera.

As another example, it is possible to control illegal parking by CCTV alone. Police officers must control illegal parking on streets to control illegal parking of vehicles, whereas an installation of a network camera makes it possible to automatically control illegal parking in the corresponding area (camera recognition area).

As another example, it is possible for a CCTV to be utilized to determine road congestion areas and control speeding vehicles. By recognizing numbers of a license plate in a CCTV of one section and measuring the time of reaching a CCTV of the next section, it is possible to check how many kilometers per hour the car has moved, in all sections of city roads and highways, and automatically impose a fine on the speeding vehicles.

As another example, it is possible for a CCTV to be utilized to control access to an apartment. It is possible to control an entrance and an exit by using a network camera only because it is possible to control entrance and exit of an apartment resident's car using the network camera.

As another example, since many CCTVs are installed on streets, the present invention can be attached to a vulnerable person or a companion animal and identify a position thereof. When the LED panel is miniaturized (capable of being downsized because the moving speed of the object is low) so that the panel can be attached to the exposed area, such as the elderly with dementia, a handicapped person, or a companion animal, a movement path thereof can be detected by the CCTV Integrated Control Center, whereby the present invention can obviate the need for an expensive GPS receiver as well as improve accuracy.

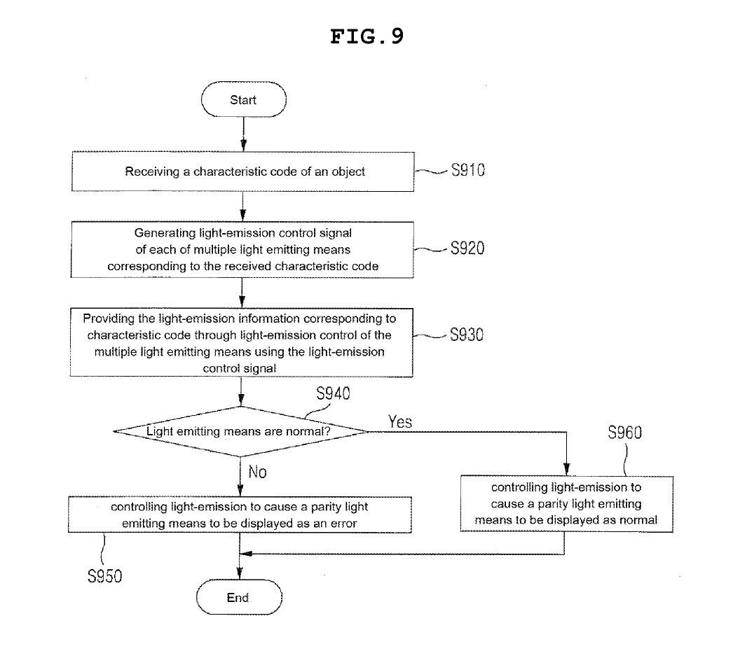

FIG. 9 is a flowchart illustrating an embodiment of an operation of providing a characteristic code in the characteristic code providing device 100 shown in FIG. 2.

Referring to FIG. 9, a process of providing a characteristic code receives a characteristic code of an object, and generates light-emission control signals of each of multiple light emitting means corresponding to the received characteristic code (S910, S920).

Herein, in step S910, the characteristic code can be directly received through a user's input in the characteristic code providing device and the code input by an external means can be received from the external means.

The multiple light emitting means can be arranged in a predetermined form at a predetermined position of the identification plate, and at least one of the multiple light emitting means can be a parity light emitting means for detecting whether multiple light emitting means are normally or erroneously operated.

In step S920, when the light-emission control signal of each of the multiple light emitting means is generated, the light-emission of the multiple light emitting means is controlled using the generated light-emission control signal to provide the light-emission information corresponding to the characteristic code of the object (S930).

In step S930, light-emission information for the characteristic code of the object can be provided by various methods of controlling the light-emission of multiple light emitting means.

In this case, in step S930, it is possible to control the light-emission color of each of the multiple light emitting means to provide the light-emission information corresponding to the characteristic code through a combination of light-emission color of each of multiple light emitting means.

At this time, in step S930, it is possible to control the light-emission on or off of each of the multiple light emitting means to provide the light-emission information corresponding to the characteristic code through a combination of on/off of each of the multiple light emitting means.

At this time, in step S930, it is possible to control the light-emission on or off of each of the multiple light emitting means to provide the light-emission information corresponding to the characteristic code through an arrangement of on-state light emitting means in light-emission on-state and an arrangement of off-light emitting means in light-emission off-state of the multiple light emitting means.

At this time, in step S930, it is possible to control a change in the light-emission color of each of the multiple light emitting means to provide the light-emission information corresponding to the characteristic code through the change in the light-emission color of each of the multiple light emitting means.

At this time, in step S930, it is possible to control a change in the light-emission on/off of each of the multiple light emitting means to provide the light-emission information corresponding to the characteristic code through the change in on/off state of each of multiple light emitting means.

When the light-emission information of each of the multiple light emitting means is provided through the step S930, it is determined whether the multiple light emitting means are normally or erroneously operated (S940). That is, it is determined whether all of the multiple light emitting means are normally operated.

As a determination result in the step S940, when it is determined that at least one of the multiple light emitting means is abnormal, the light-emission of the parity light emitting means is controlled such that the parity light emitting means is displayed as an error, and when it is determined that the parity light emitting means is normal, the light-emission of the parity light emitting means is controlled such that the parity light emitting means is displayed as normal (S950, S960).

That is, the light-emission color of the parity light emitting means is controlled according to whether the multiple light emitting means are normal, thereby determining whether the light-emission information for providing the characteristic code is normal in the characteristic code identification system.

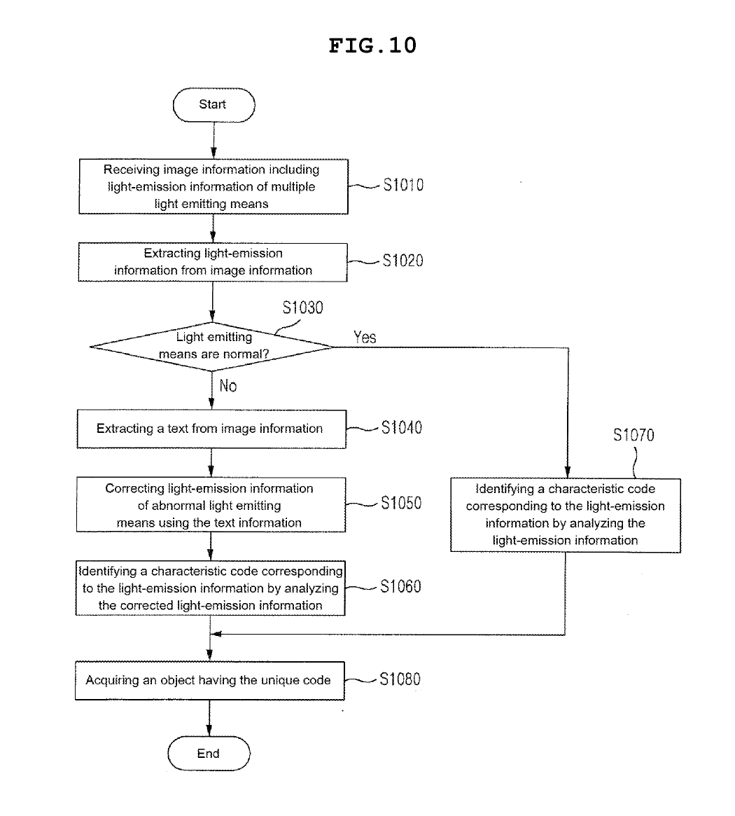

FIG. 10 is a flowchart illustrating an embodiment for an operation of identifying a characteristic code in the characteristic code identification system 300 shown in FIG. 3.

Referring to FIG. 10, in a process of identifying the characteristic code, image information including the light-emission information of the multiple light emitting means is received (S1010).

Here, in the step S1010, the image can be directly received from the image taking means for taking the image, and the image stored in an external storing means can be received from the external storage means

When the image information including the light-emission information is received in step S1010, the light-emission information of the multiple light emitting means is extracted from the received image information, and it is determined whether the multiple light emitting means that provides light-emission information are normal based on the light-emission information of the parity light emitting means of the extracted light-emission information (S1020, S1030).

In step S1020, the light-emission information for the light emitting region can be extracted from the image information using a method such as RGB, HSV, YCbCr, or the like.

As a result of determining whether the multiple light emitting means are normal based on the light-emission information of the parity light emitting means in step S1030, when it is determined that multiple light emitting means are normal, the extracted light-emission information of each of the multiple light emitting means is analyzed, and the characteristic code corresponding to the light-emission information is identified, thereby acquiring the object or object information having the characteristic code identified (S1070, S1080).

In this case, in step S1070, a combination of the light-emission color of each of the multiple light emitting means is acquired from the extracted light-emission information, thereby identifying the characteristic code through the acquired combination of the light-emission color.

At this time, in step S1070, a combination of the on/off of the light-emission of each of the multiple light emitting meansis acquired from the extracted light-emission information, and the characteristic code can be identified through the acquired combination of the on/off of the light-emission.

In this case, in step S1070, an arrangement of on-state light emitting means and an arrangement of off-state light emitting means of the multiple light emitting means are acquired from the extracted light-emission information, and the characteristic code can be indentified through the arrangement of on-light emitting means and the arrangement of the off-light emitting means.

In this case, in step S1070, a change in the light-emission color of each of the multiple light emitting means is acquired from the extracted light-emission information, thereby identifying the characteristic code through the acquired change in light-emission color.

In this case, in step S1070, a change in on/off state of each of multiple light emitting means is acquired from the extracted light-emission information, thereby identifying the characteristic code through the acquired change in on/off state.

On the other hand, as a result of determining that multiple light emitting means are normal based on the light-emission information of the parity light emitting means in step S1030, when it is determined that multiple light emitting means are abnormal, the text information is extracted from the image information, and the light-emission information of the abnormal light emitting means is corrected using the extracted text information (S1040, S1050).

If the light-emission information of the abnormal light emitting means is corrected in step S1050, the light-emission information of the multiple light emitting means including the corrected light-emission information is analyzed, thereby identifying the characteristic code corresponding to the light-emission information is identified and acquiring the object or the object information having the characteristic code (S1060, S1080).

The system or apparatus described above can be implemented as a hardware component, a software component, and/or a combination of hardware components and software components. For example, the systems, devices, and components described in the embodiments can be implemented using one or more general purpose or special purpose computers, such as, for example, a processor, a controller, an arithmetic logic unit (ALU), a digital signal processor, a microcomputer, a field programmable array (FPA), a programmable logic unit (PLU), a microprocessor, or any other device capable of executing and responding to instructions. The processing device can execute an operating system (OS) and one or more software applications running on the operating system. In addition, the processing device can access, store, manipulate, process, and generate data in response to execution of the software. For ease of understanding, the processing apparatus can be described as being used singly, but those skilled in the art will recognize that the processing apparatus can include multiple processing elements and/or multiple types of processing elements. For example, the processing apparatus can comprise multiple processors or one processor and one controller. Further other processing configurations, such as a parallel processor is also possible.

The software can comprise a computer program, a code, an instructions, or a combination of one or more of the foregoing, and can be configured to cause the processing device to operate as desired, or to instruct the processing device independently or collectively. Software and/or data can be permanently or temporarily embodied on any types of machine, component, physical device, virtual equipment, computer storage media or device, or a transmitted signal wave, in order to be interpreted by the processing apparatus or to provide instructions or data to the processing apparatus. The software can be distributed over a networked computer system and stored or executed in a distributed manner. The software and data can be stored on one or more computer readable recording media.

The method according to embodiments can be implemented in a form of program instructions that can be executed through various computer means and recorded on a computer readable medium. The computer-readable medium can include program instructions, data files, data structures, and the like, alone or in combination. The program instructions recorded on the medium can be those specially designed and constructed for the embodiment, or can be known and available to those skilled in the art of computer software.

Examples of computer-readable media include magnetic media such as hard disks, floppy disks and magnetic tapes; optical media such as CD-ROMs and DVDs; magneto-optical media such as floppy disks; Magneto-optical media, and hardware devices specifically configured to store and execute program instructions such as ROM, RAM, flash memory, and the like. Examples of program instructions include machine language code such as those generated by a compiler, as well as high-level language code that can be executed by a computer using an interpreter or the like. The hardware devices described above can be configured to operate as one or more software modules to perform operations of the embodiments, and vice versa.

While the present invention has been described in connection with what is presently considered to be the most practical and preferred embodiments, it is to be understood that the invention is not limited to the disclosed embodiments, but, on the contrary, is intended to cover various modifications and similarities. For example, it should be understood that although the techniques described can be performed in a different order than the described methods, and/or that the described components of systems, structures, devices, circuits, and the like are combined in a method other than the described method or replaced by other components or equivalents, it is possible to achieve proper result.

Therefore, other implementations, other embodiments, and equivalents to the claims are within the scope of the following claims.

1. A characteristic code identification system, comprising:
a characteristic code providing device configured to generate light-emission information corresponding to a characteristic code of an object through controlling operations of a multiple light emitting means;
an image taking means configured to generate an image information of the object including the light-emission information; and
a characteristic code identification device configured to extract the light-emission information from the image information and identify the characteristic code of the object, based on a parity light-emission information included in the light-emission information.

2. The characteristic code identification system of claim 1, wherein the characteristic code providing device comprises:
a parity light emitting means representing whether the light emitting means operates normally, and composed of at least one of the light emitting means; and
a light-emission control unit generating a light-emission control signal of each of the multiple light emitting means corresponding to the characteristic code and controlling the light-emission of each of the multiple light emitting means by using the generated light-emission control signal, thereby providing the predetermined characteristic code of the object through the light-emission of the multiple light emitting means.

3. The characteristic code identification system of claim 2, wherein the light-emission control unit controls an individual light-emission color of the light emitting means to provide the characteristic code through a combination of the light-emission color of each of the multiple light emitting means.

4. The characteristic code identification system of claim 2, wherein the light-emission control unit is configured to provide the characteristic code through an arrangement of on-light emitting means in a light-emission on-state and an arrangement of off-light emitting means in a light-emission off-state of the multiple light emitting means, by controlling light-emission on/off states of the respective the multiple light emitting means.

5. The characteristic code identification system of claim 2, wherein the light-emission control unit is configured to provide the characteristic code through the changes in the light-emission colors of each of the multiple light emitting means by controlling light-emission color changes of each of the multiple light emitting means.

6. The characteristic code identification system of claim 2, wherein the light-emission control unit is configured to provide the characteristic code through the changes the light-emission on/off of each of the multiple light emitting means by controlling changes in the light-emission on/off of each of the multiple light emitting means.

7. The characteristic code identification system of claim 2, wherein the light-emission control unit is configured to control operation of the parity light emitting means by deciding whether the light emitting means are normally operated according to the light-emission control signals for the light emitting means.

8. The characteristic code identification system of claim 2, wherein the characteristic code identification device comprises:
a receiving unit configured to receive image information including light-emission information of the multiple light emitting means taken by the image taking means;
an extracting unit configured to extract the light-emission information from the image information or text information of the object; and
an identifying unit configured to identify the characteristic code of the object by using the light-emission information or the text information of the object selectively, based on the parity light-emission information of the parity light emitting means.

9. The characteristic code identification system of claim 8, wherein the identifying unit is configured to identify the characteristic code based on the respective light-emission information on the multiple light emitting means, when the multiple light emitting means are determined as being normal based on the parity light-emission information, and when at least one of the multiple light emitting means is determined as being abnormal, compare the light-emission information of light emitting means determined as being abnormal with the text information, correct the abnormal light-emission information to the normal light-emission information and identify the characteristic code based on the corrected light-emission information.

10. The characteristic code identification system of claim 8, wherein the indentifying unit is configured to acquire a combination of light-emission colors of each of the multiple light emitting means from the extracted light-emission information and identify the characteristic code, based on the obtained information on the combination of the light-emission colors.

11. The characteristic code identification system of claim 8, wherein the indentifying unit is configured to obtain arrangement information of on-state ones, which are in a light-emission on-state, of the plurality of light-emitting devices and arrangement information of off-state ones, which are in a light-emission off-state, of the plurality of light-emitting devices, from the extracted light-emission information, and identify the characteristic code, based on the obtained arrangement information.

12. The characteristic code identification system of claim 8, wherein the indentifying unit is configured to obtain information on changes in light-emission colors of each of the multiple light emitting means from the extracted light-emission information and identify the characteristic code, based on the obtained information.

13. The characteristic code identification system of claim 8, wherein the indentifying unit is configured to obtain information on changes in light-emission on/off states of each of the multiple light emitting means from the extracted light-emission information and identify the characteristic code based on the obtained information.

14. The characteristic code identification system of claim 8, further comprising:
a chasing unit chasing a movement path of the object to which the multiple light emitting means is attached, by using the identified characteristic code; and
an acquiring unit acquiring the object to which the multiple light emitting means having the identified characteristic code is attached.

15. The characteristic code identification system of claim 14, wherein the extracting unit extracts the light-emission information by using at least one of RGB (red, green, and blue), HSV (hue, saturation, and value), and YCbCr (luminance, CbCr).
